(19) United States
(12) Patent Application Publication
(10) Pub. No.: US 2025/0001298 A1
(43) Pub. Date: Jan. 2, 2025

(54) SYSTEM AND METHOD FOR ARRANGEMENTS OF VISUAL INFORMATION IN USER-CONFIGURABLE FORMAT

(71) Applicant: INNOVATIVE TRANSDUCER IMPLEMENTATION LLC, Beltsville, MD (US)

(72) Inventors: Adam WEINER, Beltsville, MD (US); Hanuma Teja MADDALI, College Park, MD (US)

(73) Assignee: INNOVATIVE TRANSDUCER IMPLEMENTATION LLC, Beltsville, MD (US)

(21) Appl. No.: 18/140,045

(22) Filed: Apr. 27, 2023

Related U.S. Application Data
(63) Continuation of application No. PCT/US2021/065417, filed on Dec. 28, 2021.
(60) Provisional application No. 63/106,964, filed on Oct. 29, 2020.

(51) Int. Cl. A63F 13/537

(52) U.S. Cl. CPC A63F 13/537

(57) ABSTRACT

System and method are provided that allow a command center video wall and the video data it displays to be reproduced in a head-mounted display while maintaining integrated control of the video switching infrastructure and enabling secure transport of the display sources and control data between the hardware headend of the command center and the application.

This application claims priority to prior PCT Application No. PCT/US2021/0654117, filed Dec. 28, 2021, which claims priority to prior U.S. Provisional Patent Application No. 63/106,964, filed Oct. 29, 2020, the entire contents of which are incorporated herein by reference.

### BACKGROUND

### Field of Disclosure

Generally, exemplary embodiments of the present disclosure relate to methodologies and devices applicable to virtual reality (VR) command center applications, and in particular for providing large scale and arrangements of visual information in a user-configurable format within a head mounted display (HMD

### Discussion of the Background of the Disclosure

Command center operators are required to maintain situational awareness of a large array of media sources simultaneously. Traditionally command centers have utilized large arrays of displays to allow the simultaneous viewing of information across different media sources including but not limited to dashboards, video feeds, camera feeds, sensor visualizations, and data visualizations. Effective performance of the tasks required of command center operators has depended to a large extent upon the operator's physical presence within the command center to allow viewing of a large array of data sources simultaneously.

Accordingly, therein a need in the art for improved display capability and transport of data between hardware components and application.

### SUMMARY

Exemplary embodiments of the disclosure may address at least the above problems and/or disadvantages and other disadvantages not described above. Also, exemplary embodiments are not required to overcome the disadvantages described above, and may not overcome any of the problems described above.

The matters exemplified in this description are provided to assist in a comprehensive understanding of exemplary embodiments of the disclosure.

Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

Exemplary implementations of embodiments of the present disclosure provide various feature and component which may be deployed individually or in various combinations.

Exemplary embodiments of the present disclosure can allow the command center video wall and the video data it displays to be reproduced in a head-mounted display while maintaining integrated control of the video switching infrastructure and enabling secure transport of the display sources and control data between the hardware headend of the command center and the application.

An exemplary embodiment of the present disclosure provide a method and system for providing large scale and arrangements of visual information including selectively defining a user-configurable format, implementing the user-configurable format within a head mounted display, and streaming video ingest and playout in a wearable form factor.

According to an exemplary implementation, an API can be integrated into an application configured accruing to requirements of a hardware control supporting protocols including at least one of REST, TCP, UDP, RS-232, VISCA, RS-422, RS-485, USB HID, supporting the configuration for signal architecture and user-control, and a set of computer-executable instructions can be stored on non-transient computer-readable media for integrating hardware and software components.

According to further exemplary implementation, encryption and security features can be provided for the streaming.

Another exemplary embodiment of the present disclosure provides a method and system for controlling, routing and viewing sources from COTS command center in the HMD, including a microprocessor, command and data storage incorporating an open API built within a game engine facilitating interaction with at least one of, or a combination of, video routing, switching, USB KVM, USB HID, video processing hardware, camera control protocols and transcoding hardware, and other device or devices that support 3rd party control from within a User Interface in the VR environment, a user interface within the gaming engine or 3d environment comprising at least one of graphical buttons, faders, knobs, text display fields and input for graphical user interfaces; and a socket to a device receiving and processing control signals, such as a control system processor or server.

According to exemplary implementations, multiple media streaming textures can be created within a gaming engine or 3d virtual environment, such as objects that play streaming videos as a property of a surface within the 3d environment.

According to further exemplary implementations, a syntax sent from the gaming engine can be assigned to an external control server when a user interacts with the interface in the gaming engine.

According to yet further exemplary implementations, within the gaming engine or 3d environment, when a user interacts with a component of the graphical user interface, user defined commands can be sent to an external control server.

According to still further exemplary implementations, external control server can parse and repackage a syntax sent from a gaming engine using the control server to communicate with one or more external hardware devices using associated communication protocol and syntax.

### BRIEF DESCRIPTION OF THE DRAWINGS

The above and/or other example aspects and advantages will become apparent and more readily appreciated from the following description of example embodiments, taken in conjunction with the accompanying drawings in which:

FIG. 1 is a block diagram of an exemplary system for a command center with the required additions to the system to enable the architecture for remote viewing and control of the video wall via a head-mounted display

FIG. 2 is a block diagram of the required communication flows for the control of audiovisual hardware utilizing software capable of rendering a video wall within a head-mounted display.

FIGS. 3A, 3B, and 3C, and 3A1, 3A2, 3B1, 3B2, 3C1, and 3C2 are diagrammatic block and flow diagram illustrations of various components according to exemplary uses of the disclosed systems and methods.

FIG. 4 is a diagrammatic illustration of a head-mounted display, host computer, control devices and sensors typical of Virtual Reality Systems that are capable of being utilized with exemplary implementations of exemplary embodiments of disclosed systems and methods.

FIGS. 5A, 5B, 5C, and-5D are diagrammatic illustration of elements of examples of user interface according to exemplary implementations of exemplary embodiments of disclosed systems and methods.

FIG. 6A is a diagrammatic illustration of a VR or MR display, tracking and input system capable of being utilized with, or deploying, exemplary implementations of exemplary embodiments of disclosed systems and methods

FIGS. 6B and 6C are illustrative examples of various components capable of being utilized in exemplary implementations of exemplary embodiments of disclosed systems and methods.

### DETAILED DESCRIPTION

Reference will now be made in detail to the exemplary embodiments implemented according to the present disclosure, the examples of which are illustrated in the accompanying drawings. Wherever possible, the same reference numbers will be used throughout the drawings to refer to the same or like parts.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list. In addition, the terms such as “unit,” “-er (-or),” and “module” described in the specification refer to an element for performing at least one function or operation, and may be implemented in hardware, software, or the combination of hardware and software.

Various terms are used to refer to particular system components. Different companies may refer to a component by different names—this document does not intend to distinguish between components that differ in name but not function.

Matters of these exemplary embodiments that are obvious to those of ordinary skill in the technical field to which these exemplary embodiments pertain may not be described here in detail. In addition, various features of the exemplary embodiments can be implemented individually or in any combination or combinations, and would be understood by one of ordinary skill in the art of medicament delivery devices

As would be readily appreciated by skilled artisans in the relevant art, while descriptive terms such as “configuration”, “headwall”, “visual”, “virtual”, “integrated”, “screen”, “headset”, “wearable”, “3d party”, “control”, “encoder”, “decoder”, “hardware”, “software”, and others are used throughout this specification to facilitate understanding, it is not intended to limit any components that can be used in combinations or individually to implement various aspects of the embodiments of the present disclosure.

Exemplary embodiments of the present disclosure provide methods and systems for facilitating large scale and arrangements of visual information in a user-configurable format within a head mounted display (HMD), which are referred to throughout the disclosure by a descriptive, non-limiting term “Headwall” simply for clarity and conciseness.

The embodiments described herein relate to utilization of a head mounted display and virtual reality engine to decode and render video streams, transmit control messages to enable control of remote headend hardware and store/recall preset layouts either in synchronization with a physical video wall or as an extension of a physical video wall.

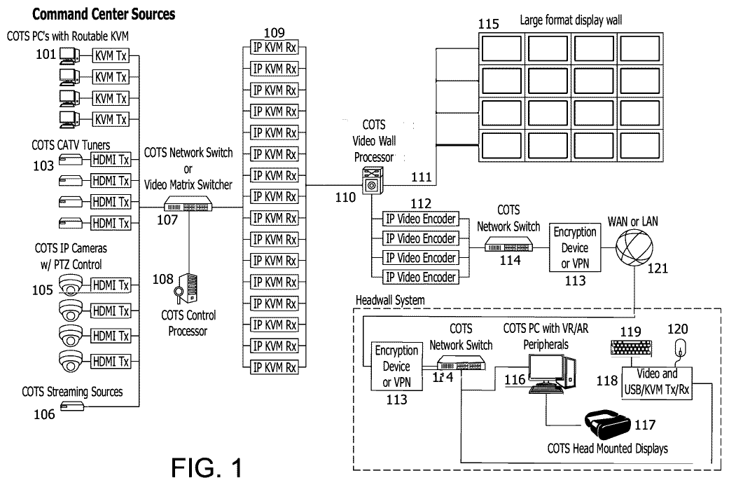

Current virtual reality systems typically utilize software on the host computer to store, process and play out video content in the 3D engine and HMD. An example of this architecture is the display of a locally stored MP4 video on a video streaming texture within the 3d environment. Under this architecture the 3d engine accesses a file on the host computer and renders it in the 3d engine to be viewed in the HMD. Another method for the display of video within a 3d engine from a remotely hosted content source, requires the transfer of data from a server to the host where it is locally buffered and played out in the 3d engine. In each scenarios a host computer, and in some implementations a server, must be loaded with software that is allowed access to the display drivers and file structures of a computer which might contain sensitive information. Such implementations are not practical for secure command center operations. Typically display devices used for the viewing of secure content must not have software packages installed that enable them to access, transmit or store sensitive data. Further display devices must be physically separated from networks with connected devices that host sensitive information. Current VR implementations that allow screen sharing and video playout, fail to provide a secure method to enable integration with traditional command center infrastructure based on technical requirements for access to files on the host or access to networks containing sensitive information. The current industry accepted secure command center video display implementation relies on hardware architectures consistent with the exemplary diagram shown in FIG. 1 inclusive only of devices 101, 102, 103, 104, 105, 106, 107, 108, 109 and 115. Such architectures by design, mitigate the possibility of data spillage. Any VR/AR solution implemented in a secure environment must act as a display device that maintains logical and physical separation from networks or hosts containing sensitive information and must not store the video images it displays.

The embodiments described herein approach these problems from a different perspective. Instead of utilizing the host computer and HMD as repository for content or a host client that accesses data from a server, the system utilizes the system exclusively for content playout of real time streams of video in the same manner that a stateless display device displays content, but neither stores nor accesses the source of the content.

Moreover, exemplary embodiments of the disclosed system and methods allow users of the system to receive and view video streams from computers and other video sources while being physically disconnected from the network that the source computers and devices generating that video are connected to, providing an enhanced level of segmentation and security.

The method used to allow operators of the disclosed system to route and switch video sources as well as control hardware devices is handled via an integrated API which is compatible with existing hardware control system processors such as the Crestron CP4, Extron IPCP, AMX Netlinks, Control 4 or any other control system processor that allows communication via IP protocols.

In this way, access to routing, switching, Camera PTZ, VTC device control and other hardware control capabilities of the system are subject to the permissions granted by the control system processor that manages control messages for the command center hardware. In an exemplary implementation, the disclosed system communicates only to the control system processor and never directly to a device, again providing an enhanced layer of compartmentalization and security.

Exemplary embodiments described herein provide technologies and techniques for using a 3D engine and VR/AR capable HMD to reproduce and arrange video images and process control messages to and from the hardware devices typically controlled by an AV Control System processor such as Video Teleconferencing Hardware, Pan-Tilt-Zoom robotic camera systems, Video Switching infrastructure, Video Processing hardware, Lighting systems, Building management systems, displays and any other device with an API, relay control, GPIO and Logic IO.

In other disclosed exemplary embodiments, systems and methods are provided for the implementation of various configurations and use cases which may be implemented utilizing the disclosed methods and system. Examples of such implementations include the provisioning of multiple VR/AR HMD systems that share the same unicast streams providing mirroring of content across all media streaming textures within the 3D engine, multiple VR/AR HMD systems that each receive their own unique unicast video streams allowing individual unique content to be displayed in each HMD and variations of the system where the VR/AR HMD system is either collocated in the command center where the video switching and streaming encoders installed or where the VR/AR HMD is remotely located and connected via a secure encrypted VPN, GRE tunnel or other TCP/IP protocol.

Exemplary embodiments described herein further can include systems and methods for generating a virtual reality environment, wherein the virtual reality environment contains one or more three-dimensional virtual controls; providing the virtual reality environment for display, through a virtual reality device; obtaining input through manipulation of the one or more virtual controls, wherein the manipulation is made using the virtual reality device and the manipulation follows at least one movement pattern associated with the one or more virtual controls; determining, based on the input, content of the one or more virtual controls, and the movement pattern associated with the manipulation, changes to the virtual environment wherein the changes are reflective of the manipulation of the one or more virtual controls; and providing the changes to the virtual reality device for display.

FIG. 1 is a block diagram of an exemplary system according to exemplary embodiments including devices/components/modules/functions 101, 102, 103, 104, 105, 106, 107, 108, 109, 110 and 115 representative of those included in a command center AV architecture to which the disclosed system can be attached to enable extension of the display wall 115 to a be viewable in a VR headset. The architecture can be scaled to support an unlimited number of input devices (101, 102, 103, 104, 105, 106) and an unlimited number of output devices (115) depending on the requirements of the system, where modules 101 are COTS personal computers with graphics cards. installed (typically HDMI or USB outputs would be available), module 102 is a COTS USB KVM transmitter that connects to a matrix switching headend. Module 101 would typically be connected to module 102 using an HDMI or Display Port cable and a USB cable depending on manufacturer. Module 103 is a non-KVM video source such as a COTS CATV receiver 104 is an HDMI transmitter which is connected to a video matrix switching headend. Module 103 and receiver 104 would typically be connected via an HDMI, Display Port or SDI cable. Module 102 and receiver 104 are connected to COTS Network Switch or Video Matrix Switcher 107 using multimode or single mode fiber or CATx cabling dependent on the application.

System 100 inclusive of devices 101, 102, 103, 104, 105, 106 and 115 comprises a standard architecture for a command center. According to exemplary implementation, for the enablement of the disclosed VR/AR and HMD extension of the system the following systems and methods can be implemented.

Additional outputs of 110, video wall processor, should be appropriately configured to enable routing of one or many sources to each of the outputs connected to 112 IP Encoder. Connection between 110 and 112 can be any video format that shares compatibility between 110 and 112. Common implementations will include HDMI, 12G SDI, Display Port and DVI for connection between 110 and 112. In an exemplary implementation, it is preferable that the output of 110 and the input of 112 be configured such that the maximum resolution per ip encoder be delivered from the video wall processor 110 to the IP Encoder 112. This can enable the maximum amount of video information to be transmitted to the VR/AR engine per stream. Multiple outputs of 110 may be connected to multiple separate instances of 112 within the same system. The process of video encoding from a baseband or HDMI signal type to and IP encoded video stream occurs utilizing the COTS IP video encoder device 112.

IP Video Encoder devices 112 will encode video signal to an IP streaming protocol which may be either Unicast or Multicast depending on the application. A wide variety of codecs may be utilized with the system, compatibility with decoding software module, as described in the exemplary implantation of Appendix C (set forth below), may be required. As new video streaming codecs are established in the market, updates to the encoding capabilities of the software module, for example as described in appendix C, may be required, however exemplary methods of implementation of the system may remain unchanged. According to an exemplary implementation, the only modification that may be required to support any new codecs would be the expansion of the decoding module, such as on described in example of Appendix C, to include said codec.

IP Video Encoders 112 can be connected to a COTS network switch device 114 using standard Ethernet protocol. Device 114 can be either a single switch or a LAN composed of multiple switches, routers, servers and hosts as required. Upon egress from the LAN for transmission across the public internet or other wide area transmission that may be intercepted by an adversary of IP Encoders 112, device 113 hardware encryption device or VPN appliance may be inserted. Under this architecture a decryption device or VPN device 113 would be inserted at the point of ingress back to a physically and logically secured LAN environment. Connection from 113 at the ingress point would then be typically connected to 114 network switch for distribution of data inside the LAN. According to an exemplary embodiment, the principal of this portion of the system is that hardware encryption devices 113 can be implemented as a part of the system where the signals encoded by 112 require encryption and transmission in a secure manner.

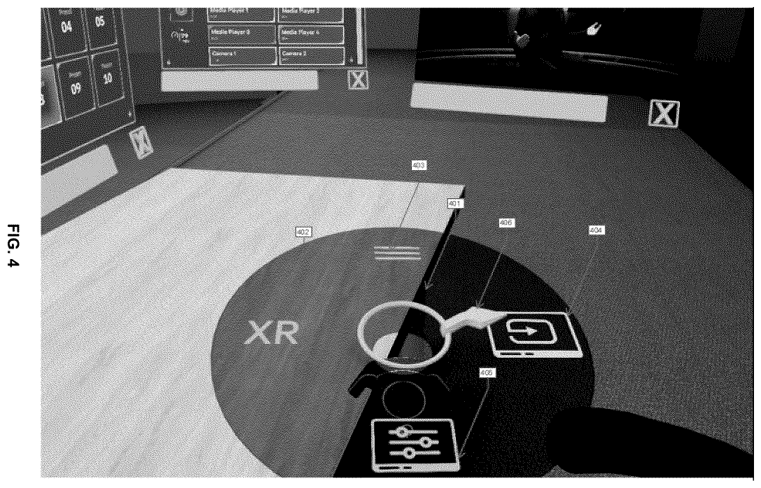

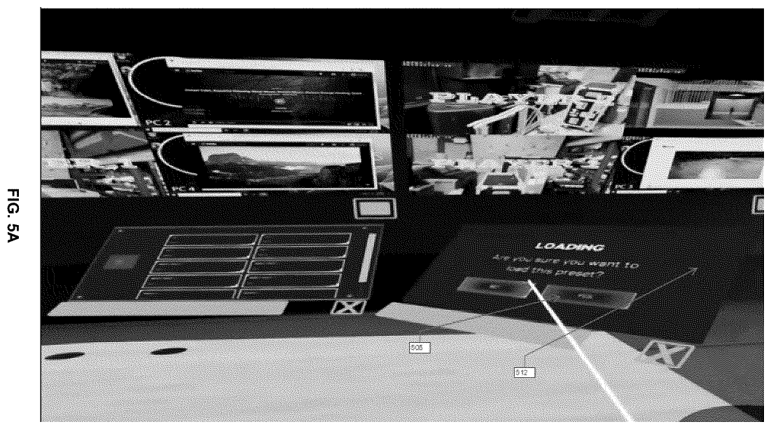

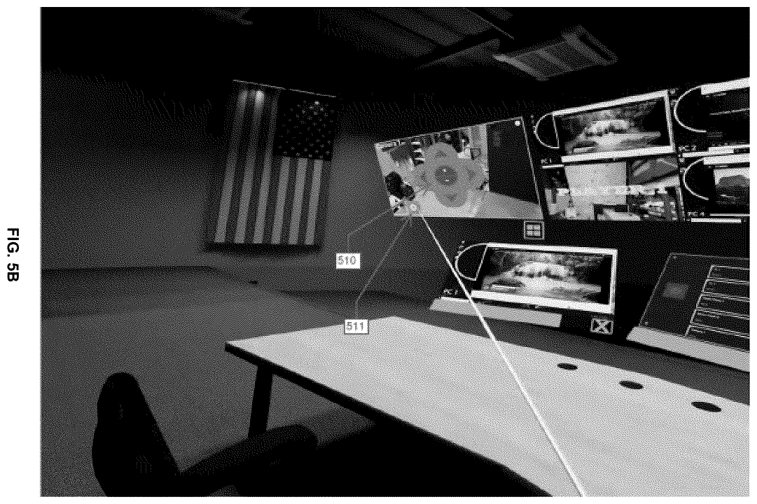

According to exemplary embodiments, COTS PC with VR/AR Peripherals, device 116 can be connected to network switch 114 via standard Ethernet fiber or copper cabling. Ip network streams sent from devices 112 are received, processed, and played out in the 3d Engine hosted on device 116. Playout within the 3D engine can be handled using the method such as those described in Appendix C or by any other means sufficient to render the video to a texture within the 3D engine. Ip streaming video is processed, decoded, and recomposed into a video image. The video image is rendered and displayed on a 2-dimensional surface texture within the 3d environment. The texture is commonly referred to in COTS 3d engines as a media streaming texture. An example of media streaming texture is shown in FIG. 5C, display 501.

According to exemplary embodiments, arrangement and positioning of individual source video content from within the pixel space of the video encoding device 112 can be managed by the video processing external hardware device 110. For example individual inputs sources 101, 103, 105 and 106 can be arranged within a single video stream based on the windowing configuration applied in device 110. The result of the arrangement of input sources by device 110 can be observed in FIG. 5B where individual media streaming textures can contain one image or many images.

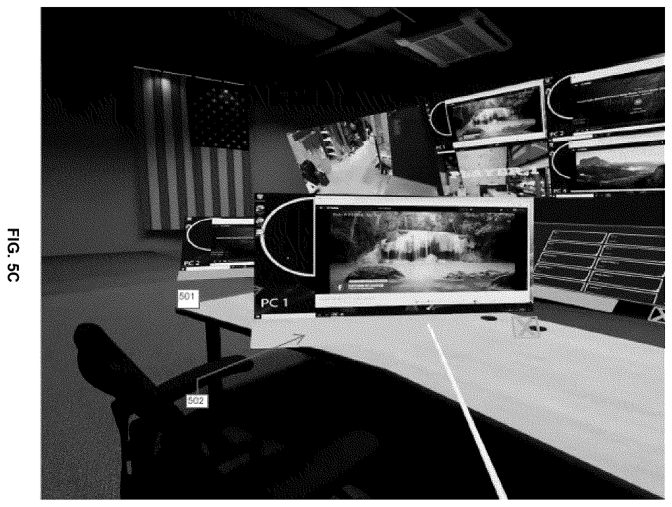

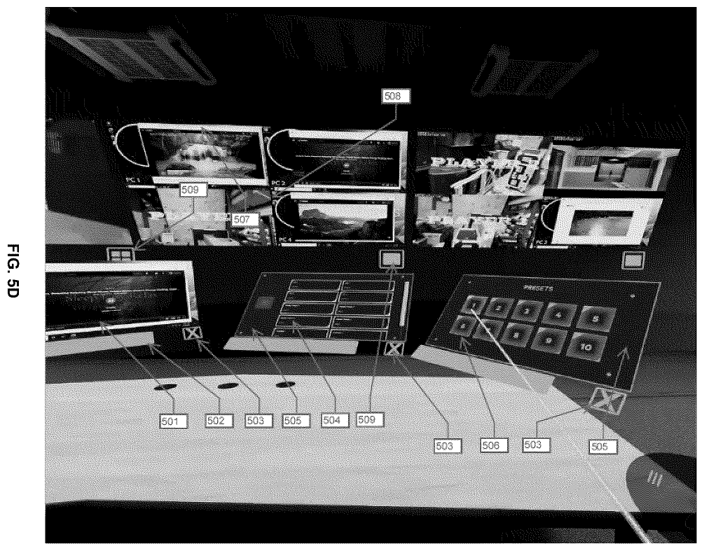

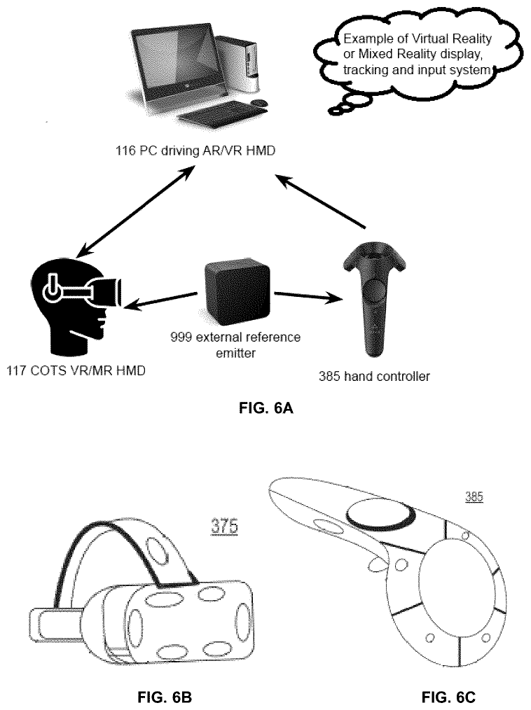

According to an exemplary implementation of disclosed embodiments, a critical component of the disclosed system is control of the external video switching and routing hardware from within the 3d engine using COTS control devices such as device 385 depicted in a non-limiting example of FIG. 6C. In traditional command center designs, routing, switching, video processing and device control is managed by a control system processor, device 108. An example of an API described in Appendix A provides a method for the communication of control commands between the COTS PC 116 and control processor 108. By utilizing a virtual pointer to select user interface components within the 3D engine as depicted in the examples of FIGS. 5A, 5B, 5C, and 5D it is possible to control video source-destination routing, video wall layouts and arrangements, USB-KVM routing, audio routing, robotic camera control as well as preset arrangement storage and recall.

FIG. 4 shows an example of a screen capture of the rotary control UI utilized to enable various modes of control and content viewing within the VR environment, according to exemplary implementations f disclosed embodiments. A rotary menu 401 can be operated from a typical COTS VR controller. A button 402 can be provide to allow the user to toggle between VR and Augmented reality modes using video pass through cameras to superimpose all menu and video features over a live video feed from cameras mounted on the headset. This can be typically referred to as Augmented Reality or Extended Reality. A preset window launch buttonv403 can also be provided such that, for example, pressing control button 403 causes the preset control menu 505 to show and hide within the environment. A magnification window launch buttonv404 can also be provided such that pressing the button 404 will pop up magnification window 501. A source selection page popup button 405, can also be provided such that pressing button 405 will pop up source selection control menu 505. A rotary selector 406 can be controlled for example by placing the users thumb over the rotary selection button on a COTS VR controller.

FIGS. 5A-5D are screen captures showing exemplary implementations of embodiments of the disclosed system user interface as viewed in a VR headset as device 375 depicted in a non-limiting example of FIG. 6B. In an exemplary implementation, a magnification window can be conceptualized as a display in the virtual environment. The magnification window 501 is a virtual object in the 3d environment with a media streaming texture applied to the object. The media streaming texture is connected logically in software such as to ffmpeg software plugin as set forth in the example of Appendix C. In the example of Appendix C, the plugin has a stream url field that can be user defined. When a stream URL is present at the defined address the magnification window will then display video on the media streaming texture.

According to exemplary implementations of various embodiments of the present disclosure, there can be provided a positioning control 502 for the magnification window. The magnification window can be positioned in the 3d environment by selecting the positioning control bar 502 and dragging the window in the 3d space. Controls have been enabled for X,Y,Z positioning of the magnification window in the coordinate plane of the 3d environment.

According to exemplary implementations of various embodiments of the present disclosure, there can be provided a close window button 503 which allows the magnification window to be closed, hiding it from view in the 3d environment.

According to exemplary implementations of various embodiments of the present disclosure, there can be provided a source control menu 504. This menu contains sources configured via a web application hosted on COTS control processor 108. The sources shown on this UI element are representative of physical video inputs to the system as shown in 101, 103, 105 and 106. The naming and configuration of sources is executed via a web browser. In the VR application, the user is able to select a source as shown in 505 and route it to a destination as shown in 507. In so doing, a command is sent from COTS PC 116 to processor 108 utilizing API such as in the example of Appendix A, a physical video source 102 is switched at the video matrix switcher 107 to an input of the COTS video wall processor 110, video outputs of the processor 110, video wall processor are physically connected to the IP video encoders 112 at the stream URLs defined by the user during system setup. IP video streams are decoded and displayed in in the 3d environment on the media streaming texture.

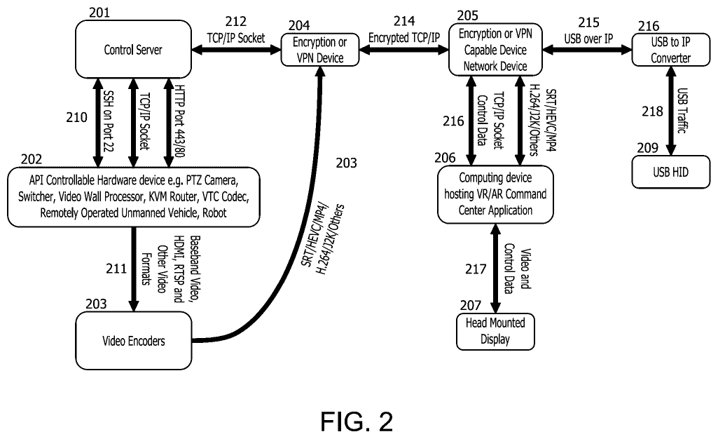

According to exemplary implementations of various embodiments of the present disclosure, there can be provided a source selection button 505. Source selection buttons are representative of physical video sources connected to the system. By selecting a 505 source and then selecting a virtual display 507, API commands are sent to the hardware devices as shown in FIG. 2 such that physical video routes are executed resulting in the video being displayed in the 3d environment.

According to exemplary implementations of various embodiments of the present disclosure, there can be provided a preset button 506. Presets are storable and recallable configuration methods by which a user can store all information related to source/destination routing, video wall processor settings and x,y,z positioning of windows in the 3d environment. A preset is stored by clicking and holding for 3 seconds on a typical 506 type button. The software will prompt with a message confirming the user wishes to overwrite the particular preset after the button is held for 3 seconds. When the preset button is clicked and released in under 3 seconds, all parameters stored in that preset are recalled and displayed in the 3d environment. All parameters related to presets are stored on the COTS Control processor 108 to prevent any data related to source/destination routing or windowing from being stored on the PC 116.

According to exemplary implementations of various embodiments of the present disclosure, there can be provided a virtual display 507 with media streaming texture applied. The virtual display is an object in the 3d environment, the media streaming texture is a software component that enables playout of video as a texture applied to an object.

FIG. 5D, illustrates an exemplary image 508 of the application of a video wall processor for windowing of display sources within a single stream according to exemplary implementations of various embodiments of the present disclosure.

According to exemplary implementations of various embodiments of the present disclosure, there can be provided a windowing control button 509 that allows control of the 110, video wall processor, associated with the display 507, virtual display with media streaming texture applied. By selecting this control button in the application, a command can be transmitted as depicted in FIG. 2 which results in a modification of the tiling of video sources at the output of the 110 video wall processor. The result is a change in the arrangement of sources shown on a virtual display507.

FIG. 5B illustrates an exemplary image 510 of the specialty controls available for sources defined as compatible with robotic pan tilt zoom control parameters for cameras according to exemplary implementations of various embodiments of the present disclosure. When a camera source is routed to a virtual display507, controls are displayed to enable the user the ability to send ptz control messages to a type 105 device capable of robotic or cropping based ptz control.

FIG. 5B further illustrates an exemplary image 511 of the specialty control open/close parameter to enable ptz control buttons to be displayed or hidden over the virtual display 507 media streaming texture of a compatible routed source according to exemplary implementations of various embodiments of the present disclosure.

FIG. 6A is a diagrammatic illustration of an example of virtual reality (VR) of mixed reality (MR) display, tracking and input system including a PC 116 driving AR/VR HMD, and COTS VR/MR HMD 117 and controller 385, with an external interface emitter 9999 in communication therewith.

While the present disclosure has been shown and described with reference to certain exemplary embodiments thereof, it will be understood by those skilled in the art that various changes in form and details may be made therein without departing from the spirit and scope of the embodiments of the present disclosure.

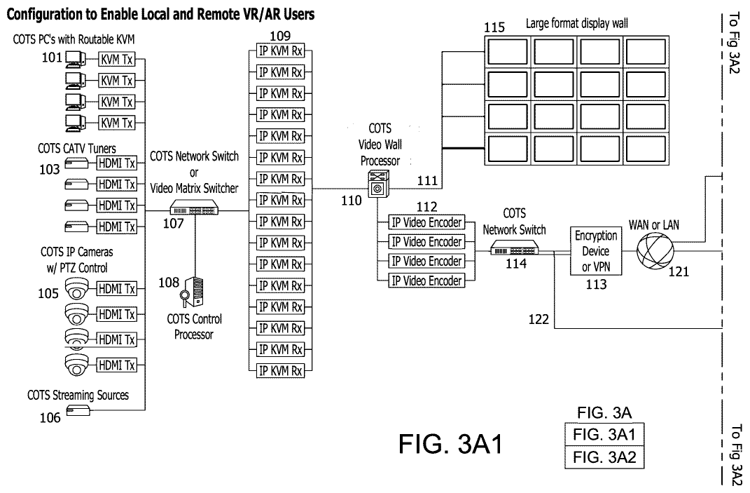

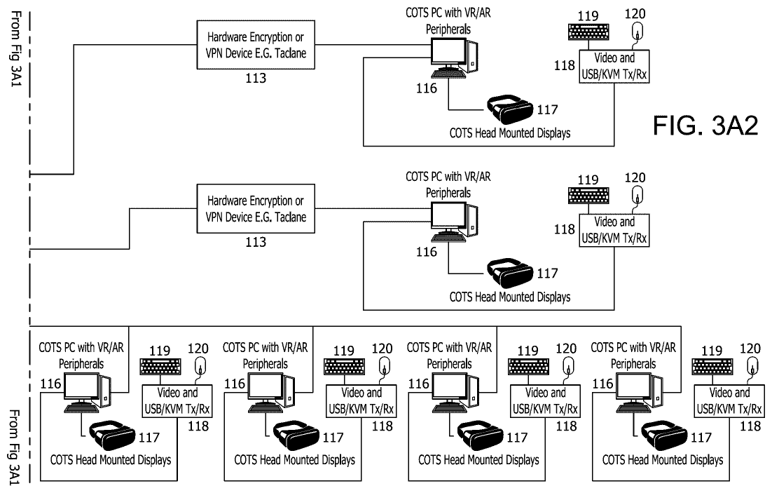

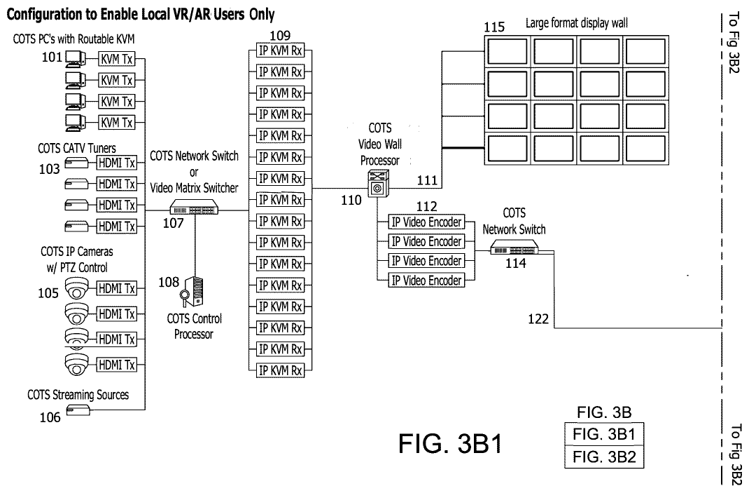

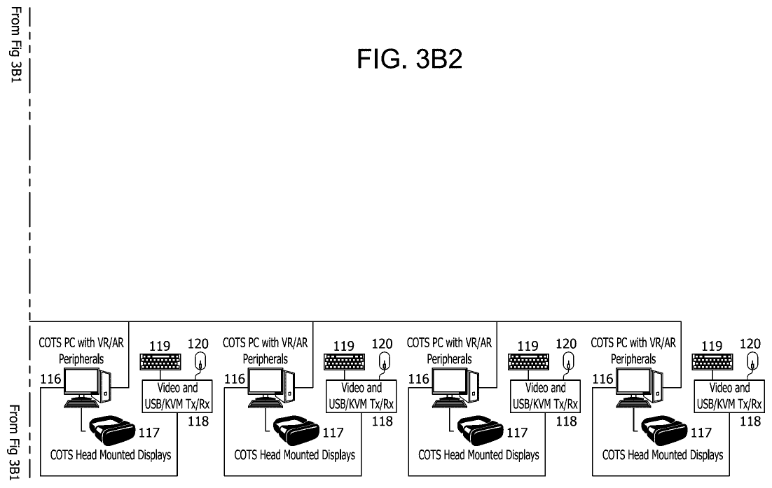

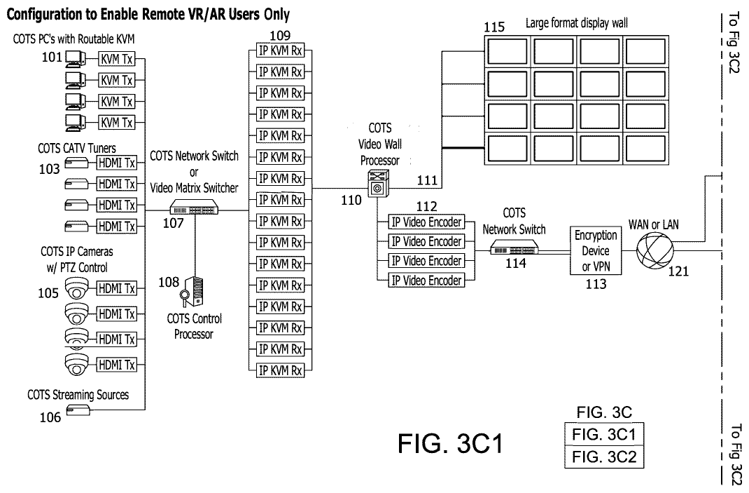

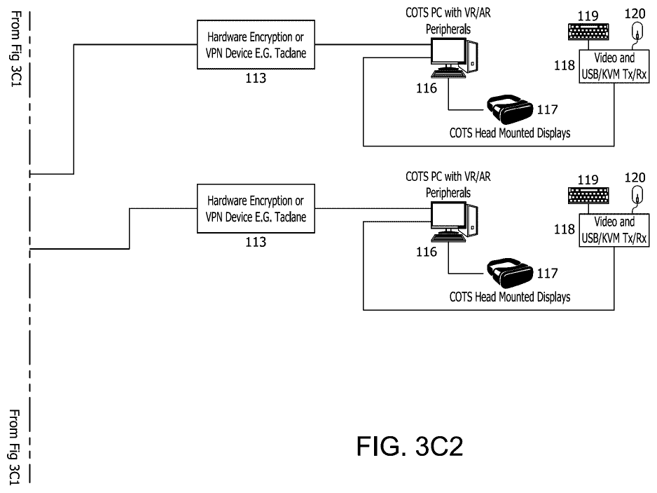

For example, US patent application Pub. No. US 2018/0082477 A1 dated Mar. 22, 2018, the entire disclosure of which is incorporated herein by reference, contains examples of conventional VR systems, where for example, FIGS. 3A, 3B and 3C, and 3A1, 3A2, 3B1, 3B2, 3C1, and 3C2 of Pub. No. US 2018/0082477 A1 illustrate components of a VR system of the type that can be used complimentarily with, or improved by, exemplary embodiments described in this disclosure.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

Exemplary non-limiting implementations of embodiment s of the present disclosure are further described in the enclosed Appendices A-C, which are included in, and made part of, the present disclosure, to aid still further in the description of exemplary technology associated therewith, where:

APPENDIX A provides an exemplary API Reference document demonstrative of the required control command set and possible syntax protocols between the VR/AR Command center application and the connected hardware control server.

APPENDIX B provides an exemplary source code for control system communication with VR/AR Command Center application as well as external hardware that can be controlled via the VR/AR Command Center user from within the AR/VR Command Center application

APPENDIX C provides exemplary Diagrams and descriptions of FFMPEG Optimization for VR/AR utilization in the VR/AR Command Center application.

Those of skill in the art would understand that a computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (for example, by operating on input data and/or generating an output). Method steps can also be performed by, and apparatus of the illustrative embodiments can be implemented as, special purpose logic circuitry, for example, an FPGA (field programmable gate array) or an ASIC (application-specific integrated circuit), for example.

The various illustrative logical blocks, modules, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. Information carriers suitable for embodying computer program instructions and data include all forms of non-volatile memory, including by way of example, semiconductor memory devices, for example, electrically programmable read-only memory or ROM (EPROM), electrically erasable programmable ROM (EEPROM), flash memory devices, and data storage disks (for example, magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

In addition, the included drawing figures further describe non-limiting examples of implementations of certain exemplary embodiments of the present disclosure and aid in the description of technology associated therewith. Any specific or relative dimensions or measurements provided in the drawings other as noted above are exemplary and not intended to limit the scope or content of the inventive design or methodology as understood by artisans skilled in the relevant field of disclosure.

Other objects, advantages and salient features of the disclosure will become apparent to those skilled in the art from the details provided, which, taken in conjunction with the annexed drawing figures, disclose exemplary embodiments of the disclosure.

We claim:

1. A method for providing large scale and arrangements of visual information, the method comprising:
selectively defining a user-configurable format;
implementing said user-configurable format within a head mounted display; and
streaming video ingest and playout in a wearable form factor.

2. The method of claim 1, wherein
an API is integrated into an application configured accruing to requirements of a hardware control supporting protocols including at least one of REST, TCP, UDP, RS-232, VISCA, RS-422, RS-485, USB HID, supporting said configuration for signal architecture and user-control of said head mounted display, and
a set of computer-executable instructions are stored on non-transient computer-readable media for integrating hardware and software components associated with said application.

3. The method of claim 2, further comprising associating encryption and security features with said streaming.

4. A system for controlling, routing and viewing sources from COTS command center in HMD, the system comprising:
a microprocessor, command and data storage facilitating interaction with at least one of, or a combination of, video routing, switching, USB KVM, USB HID, video processing hardware, camera control protocols and transcoding hardware, and other device or devices that support 3rd party control from within a User Interface in the VR environment;
a user interface comprising at least one of graphical buttons, faders, knobs, text display fields and input for graphical user interfaces; and
a socket to a device receiving and processing control signals, the device comprising a control system processor or a server,

5. The system of claim 4, wherein
multiple media streaming textures are created within a gaming engine or 3d virtual environment,
a syntax sent from the gaming engine is assigned to an external control server when a user interacts with the interface in the gaming engine,
within the gaming engine or 3d environment, when a user interacts with a component of the graphical user interface, user defined commands are sent to an external control server, and
external control server parses and repackages a syntax sent from a gaming engine using the control server to communicate with one or more external hardware devices using associated communication protocol and syntax.

6. The system of claim 5, wherein the multiple media streaming textures include objects that play streaming videos as a property of a surface within the 3d environment.

7. The system of claim 4, wherein said microprocessor, command and data storage incorporates an open API built within a game engine facilitating said interaction with said at least one of, or a combination of, video routing, switching, USB KVM, USB HID, video processing hardware, camera control protocols and transcoding hardware, and other device or devices that support 3rd party control from within said User Interface in the VR environment.

8. The system of claim 5, wherein said user interface is within said gaming engine or 3d environment.

9. The system of claim 7, wherein said user interface is within said gaming engine or 3d environment.
